(19) United States
(12) Patent Application Publication
(10) Pub. No.: US 2005/0243797 A1
(43) Pub. Date: Nov. 3, 2005

(54) Method for selecting useful routes in a router for even traffic distribution in a communications network

(75) Inventor: Karl Schrodi, Geretsried (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/432,040

(22) PCT Filed: Sep. 20, 2002
(86) PCT No.: PCT/DE02/03537

§ 371 Date: Oct. 21, 2003

(30) Foreign Application Priority Data
Sep. 20, 2001 (DE) 101 46 349.9
Dec. 14, 2001 (DE) 101 61 547.7

(51) Int. Cl. H04L 12/66

(52) U.S. Cl. 370/352

(57) ABSTRACT

Connectionless Internet protocols make use of the principle of routes. The routes implicitly lay down which path the data packets of a communication relation (flow) will take through the network. When a data packet of a so far unknown flow occurs for the first time, the router selects a route which is used for all subsequent data packets of said flow. These routes usually terminate on the same neighboring node. The aim of the invention is to achieve an adequate quality of service (QoS) also for connectionless communication networks, by evenly distributing the flows to the mutes in the network in order to achieve an as even a distribution of traffic as possible, which conventional distribution fan-out structures have so far been incapable of achieving. According to the invention, a selection of useful routes between the router and the target address via which the information is guided to the target is locally determined in the router.

### CLAIM FOR PRIORITY

This application claims priority to International Application No. PCT/DE02/03537 which was published in the German language on Mar. 27, 2003.

### TECHNICAL FIELD OF THE INVENTION

The present invention relates to a method of creating a distribution fan-out structure, and in particular, in a router assigned to a communication network via which data packets can be routed to a target address.

### BACKGROUND OF THE INVENTION

In the past, two main types of communication networks for transferring information have emerged: Packet-oriented data networks and circuit-oriented voice networks. One of the ways in which these two network types differ from one another is in their requirements as regards Quality of Service QoS.

QoS—an abbreviation for Quality of Service—is defined differently depending on the context and consequently assessed using different metrics in each case. Known examples for metrics to measure Quality of Service and the quantity of information transferred (bandwidth), the quantity of information not transferred (loss rate), the—if necessary averaged—time delay for the transfer (delay), the—if necessary averaged—deviation from the otherwise normal gap between two information transfers (delay jitter), or the quantity of information initially not allowed to be transferred at all (blocking rate).

Circuit-oriented voice networks are designed for the transmission of continuous streams of (speech) information (conversation, call or session). These networks normally transmit this information with a high quality of service. For speech for example it is important to have a minimum delay of typically <200 ms without delay jitter, since the reproduction of speech in the receiving unit demands a continuous flow of information. Hence, it is not possible to compensate for information that has not been transmitted by re-transmitting it. Such a loss therefore results in a perceptible audible clicking sound in the receiving device. In the technical world the transmission of speech is referred to in general terms as a real time (transmission) service. The quality of service is achieved by the corresponding dimensioning and planning of the voice networks, in which case the transmission capacity itself is not subject to variations as a result of the circuit orientation.

Packet-oriented data networks are designed for the transmission of streams of data packets or packet streams. As a rule, it is not necessary to guarantee any high quality of service here. Without a guaranteed quality of service, the streams of data packets are transmitted for example with variations in delay since the individual streams of data packets are normally transferred in the sequence of their network access, i.e. the more packets to be transmitted by a data network, the greater the delays (non-real time service).

The best-known data network is currently the Internet. The Internet is designed as an open (wide-area) data network with open interfaces for connection of (mostly local and regional) data networks from different manufacturers. The main emphasis therefore has previously been on providing a non-proprietary transport platform. Adequate mechanisms to guarantee quality of service play a subordinate role.

As part of the convergence of circuit-oriented voice and packet-oriented data networks, voice transmission services and in the future broadband services, such as the transmission of moving picture information, will also be implemented in packet-oriented data networks, i.e. real time services that are otherwise normally circuit oriented are transmitted packet-oriented in a convergent voice-data network, i.e. in packet streams (real-time packet streams). The problem that arises here is that packet-oriented implementation of a real time service requires a high quality of service to make it qualitatively comparable with circuit-oriented transmission, whereas for example the Internet does not provide any adequate mechanisms to guarantee a higher quality of service.

In principle, ATM networks would for example then be suitable for safeguarding the quality of service (QoS) in data networks. ATM is a connection-oriented technology. All cells (packets) of a connection (VP, VC) follow the same path. ATM however requires a very high level of complexity since all the connection-related data must be stored in the network. These considerations apply equally to the MPLS transmission procedures used in IP networks which practically transfers the ATM world into the internet.

With its connectionless protocols the Internet uses the principle of “routing.” The routes implicitly define which paths the data packets of a communication relation (flow) will take through the network. When a data packet of a flow that was not known up to that point first occurs, the router (autonomously and individually) selects a route which it enters into its routing tables and then uses it for all subsequent data packets of this flow. Although these routes (for purposes of increasing the available bandwidth) can comprise a number of physical links, all these links (with the same length or delay) end at the same neighboring node. This principle is designed to ensure that no transposition of the packet sequences occurs since many TCP applications react very badly to transpositions because of their lack of implemented re-sequencing mechanisms. This means that other traffic is not equally distributed to all nodes.

For support of real-time applications over packet-oriented networks, the traffic should be distributed as equally as possible in accordance with specific rules to all nodes and connection links in the network.

A large number of different mechanisms and variations for individual distribution of data packets to outgoing trunk groups are known. These include:

1. Simple distribution of the incoming traffic to an outgoing trunk group without priorities (advance distribution of the traffic into individual queues per port, use of a single queue with the multi-server principle).

2. Distribution of the incoming traffic to an outgoing trunk group with priorities (advanced distribution of the traffic into individual priority queues per port, multi-server principal each with a queue per priority class).

3. Distribution of the incoming traffic to an outgoing trunk group with priority-controlled “Per flow” queuing (e.g. Weighted Fair Queuing (WFQ)).

With all the procedures given above, when the queues are implemented only one pointer (address) is stored to identify the relevant data packets in a normally shared data memory. The sequence of operation is produced implicitly from the sequence of entries in the queue (e.g. in accordance with the FIFO principle) or from the upstream procedure for selecting the queue to be serviced next (e.g. according to priority and with the same priority cyclically or longest (or shortest) queue first, according to weighting (WFQ), . . . ).

This procedure, which is used in the current status of technology, cannot however bring about an even distribution of the traffic.

### SUMMARY OF THE INVENTION

The invention discloses a method of how, in the network nodes of a connectionless communication network, the traffic can be distributed in the optimum possible way to the outgoing connection links.

Advantageous for the invention is a simple solution that can be implemented at low cost. Here, the network nodes act independently on the basis of rules specified to them in advance and information that they receive. In particular, they are in a position to independently dynamically determine the distribution pattern needed in each case and if necessary the distribution criteria to be applied to it.

To this end, routing protocols are exchanged between the routers in the communication network. These feature information relating to the network configuration. According to this network configuration, an assignment is made locally in each router of the target addresses to possible physical paths via which the data packets reach the target. From these possible routes, a choice is then made in accordance with the quality criteria and is stored in a router's own database.

The quality criteria here can be criteria relating to quality of service, criteria relating to path information or cost criteria. In each case, loop formation should be avoided. The criteria should be selected in such as way that the conventional Internet protocol procedures (best effort, shortest path) are also possible.

### BRIEF DESCRIPTION OF THE DRAWINGS

The invention is explained below in more detail using an exemplary embodiment, in which:

FIG. 1 shows a network configuration according to an embodiment of the invention.

### DETAILED DESCRIPTION OF THE INVENTION

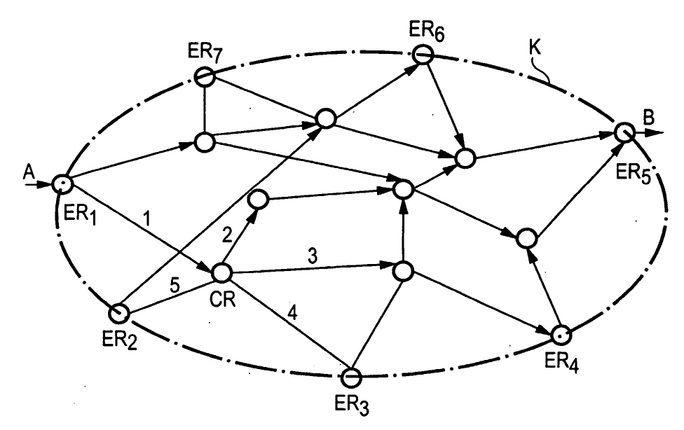

FIG. 1 shows a network configuration in which the methods according to the invention are executed. Accordingly, the FIGURE shows a communication network K comprising a number of intermeshed routers. The routers are divided into edge routers ER or core routers CR, depending on whether they are located on the edge of the communication network or within it.

For purposes of the example, it may be assumed that data packets penetrate communication network K via node A, in which Edge Router ER1 is located, and leave the communication network again via node B, in which Edge Router ERS is located. In accordance with the invention, a decision is made on the basis of a distribution fan-out structure in each router as to the paths over which the data packets are to be routed in communication network K. Since, depending on the service to be used, a quality of service QoS is to be guaranteed, the data packets are to be distributed as evenly as possible on the paths in the network.

Not all physically possible paths within communication network K are selected, but preferably those that are most useful. In this case, the current network configuration is preferably stored in each router. Each router obtains knowledge of the network configuration by exchanging routing protocols with the other routers. This represents the preferred solution since, in this case, the network operator does not need to make any additional effort when adding a new router to the network. Of course, each router could also obtain the network configuration from a higher-ranking control device. This means that each of the routers has a current image of the network configuration valid at the time. The addition or removal of routers (failure) will therefore be stored after a certain lead time in all databases of the routers involved.

On the basis of the current network configuration, the physically possible paths that cannot take a data packet to its actual target when it leaves router CR are first determined in each router. In the present exemplary embodiment, for the (Core) Router CR, these are the paths 1, 2, 3, 4, 5. This assigns the physically possible paths to the target address.

Not all physically possible paths can for example be usefully used to guarantee the quality of service. This applies for example in accordance with the FIGURE to paths 1, 4, 5 to the edge routers ER₁, ER₂, ER₃. For this reason, a choice is made in accordance with the invention from the physically possible paths. In particular, criteria in respect of Quality of Service (QoS) should be used as a criterion. This can, for example, include the criterion that the delay time for transmission in communication network K should be as short as possible. In this case paths 2, 3 will be considered in this selection.

As further selection criteria, paths to the edge routers can basically be excluded in the network.

As further selection criteria relating to Quality of Service QoS a path can be selected that in the past statistically exhibited the best behavior as regards the amount of information transmitted (bandwidth), the amount of information not transmitted (loss rate), the—if necessary averaged—deviation from the otherwise normal gap between two information transmissions (delay jitter), or the amount of information as yet not allowed for transmission at all (blocking rate).

Cost criteria can come in useful as further selection criteria. If services are selected in which the delay plays less of a role than the cost aspect, the routes that ensure these lower costs are to be selected.

The solution (basic principle) services each data packet with the minimum possible delay (provided any possibility of servicing/packet transmissions already started being aborted is excluded) and thereby makes possible the best possible quality, even for interactive real time applications for example. The use of an additional “timestamp” for intermediate storage (queuing) of the data packets can be implemented both in SW and in HW with simple resources and taking relatively little time. Since this mechanism is only relevant locally, there is no problem in network usage, even in “mixed” networks. The same also applies to the alternatives and variants named and shown.

The aim of both the preferred solution according to the basic principle as well as the (simpler) alternatives also specified is the most even distribution possible of the traffic, taking account of the corresponding prioritization. The specified variants show how a desired “skewed” distribution can be achieved, with or without a delay criterion.

The suggested adaptive control, regardless of whether it is performed locally in the node or by a higher-ranking entity, makes possible an idealized traffic distribution in accordance with specified target values (equal or “skewed”) even if interferences between the individual distributions in the individual trunk groups through the partly mutually overlapping trunk groups lead to problems with the desired equilibrium (the system “adjusts itself”).

Combining the suggested procedures and mechanisms in any way, a) time criterion per package for delay optimization on arbitration, b) (different) methods of setting a specified traffic distribution, even “skewed” if necessary, c) adaptive control to the desired distribution pattern, allows a very flexible use of the solutions that can be optimized for almost any network application.

1. A method of creating a distribution fan-out structure in a router assigned to a communication network via which data packets can be routed to a target address, comprising:
exchanging routing protocols that include information regarding the network configuration in the communication network; and
determining the assignment of target addresses to physically viable routes using the network configuration as a measure, such that a selection of the physically viable routes can be made in accordance with quality criteria.

2. The method according to claim 1, wherein the routing protocols are exchanged between routers of the communication network.

3. The method according to claim 1, wherein the routing protocols are exchanged between a higher-level control device and routers of the communication network.

4. The method according to claim 1, wherein the quality criteria are criteria related to Quality of Service of a connection.

5. The method according to claim 1, wherein the quality criteria are criteria related to cost of transmission.

6. The method according to claim 1, wherein the quality criteria are criteria related to route information.

7. The method according to claim 1, wherein the communication network is a packet-oriented communication network operating as a connectionless network.
